(19) United States
(12) Patent Application Publication
(10) Pub. No.: US 2019/0118455 A1
(43) Pub. Date: Apr. 25, 2019

(54) PROCESS TO PREPARE SEQUENTIALLY STRETCHED BIAXIALLY ORIENTED FILM

(71) Applicant: DSM IP Assets B.V., Heerlen (NL)

(72) Inventors: Roman STEPANYAN, Echt (NL); Hao CHEN, Echt (NL)

(21) Appl. No.: 16/090,647

(22) PCT Filed: Apr. 3, 2017
(86) PCT No.: PCT/EP2017/057828

§ 371 Date: Oct. 2, 2018

(30) Foreign Application Priority Data
Apr. 5, 2016 (EP) 16163902.6

(51) Int. Cl. B29C 55/12; C08J 5/18

(52) U.S. Cl. CPC B29C 55/12; C08J 2477/06; C08J 2377/02; C08J 5/18

(57) ABSTRACT

The invention relates to a process for preparing a sequentially stretched biaxially oriented film, comprising the following steps: a) Melting a composition comprising at least 50 wt % with respect to the total amount of the composition of a copolyamide comprising: i. At least 75 wt % monomeric units derived from caprolactam, and further monomeric units derived from diamines X and/or diacids Y and/or aminoacids Z in a summed amount of between 0.2 to 25 wt %; or ii. At least 75 wt % monomeric units derived from hexamethylene diamine and adipic acid, and further monomeric units derived from diamines X and/or diacids Y and/or aminoacids Z in a summed amount of between 0.2 to 25 wt %; into a polymer melt; b) Casting the polymer melt through a planar die to form a film of at least one layer and subsequently quenching the film to a temperature of below Tg of the copolyamide, while the film is transported in a direction, referred to as machine direction; c) Stretching the film obtained after quenching in a direction parallel to the machine direction (MD-stretching) with a draw ratio DR_{MD} at a temperature of at least Tg of the copolyamide; d) Stretching the film obtained after MD stretching in a direction transversal to the machine direction (TD-stretching) with a draw ratio DR_{TD} at a temperature of at least Tg+10° C. of the copolyamide; e) Heat setting the film obtained after cooling and stretching, at a temperature of between Tm−70° C. and Tm of the copolyamide; in which Tg and Tm of the copolyamide are determined as described by ASTM D3418-03, with a heating and cooling rate of 10° C. per minute, in which DRMD/DRTD is at least 0.8 and DR_{MD}×DR_{TD} is at least 10. The invention also relates to sequentially stretched biaxially oriented film.

This invention relates to a process to prepare sequentially stretched biaxially oriented film, as well as a film obtainable by the process, as well as flexible packaging comprising the film.

Processes to prepare biaxially oriented films are known in the art and are for example described in EP0764678B1. EP0764678B1 discloses biaxially oriented polyamide films and a method of production in which a cooling process is interposed between the transverse drawing (also referred to as TD stretching) and the heat-setting process. This results in a film showing uniform physical and chemical properties in the transverse direction. Biaxially oriented films are often printed. During printing, several layers of different colors are printed over each other to provide a full color image. It is therefore important that these layers are exactly matching each other, as otherwise the printing will become unsharp.

With sequentially stretched biaxially oriented polyamide films, humidity causes excessive shrinkage or expansion, which causes the printing layers to no longer exactly overlap, especially in TD direction, and thus gives an unsharp printing. One solution to this problem is to simultaneously stretch the film in two directions, instead of sequential. However, this requires special equipment and modification of a film producing line.

It is thus an object of the present invention to have a process for preparing sequentially stretched biaxially oriented film, which exhibits less shrinkage or expansion, and thus allows higher quality for printing.

This has been achieved by a process for preparing a sequentially stretched biaxially oriented film, comprising the following steps:
a) Melting a composition comprising at least 50 wt % with respect to the total amount of the composition of a copolyamide comprising:
   i. At least 75 wt % monomeric units derived from caprolactam, and further monomeric units derived from diamines X and/or diacids Y and/or aminoacids Z in a summed amount of between 0.2 to 25 wt %; or
   ii. At least 75 wt % monomeric units derived from hexamethylene diamine and adipic acid, and further monomeric units derived from diamines X and/or diacids Y and/or aminoacids Z in a summed amount of between 0.2 to 25 wt %;
      into a polymer melt;
b) Casting the polymer melt through a planar die to form a film of at least one layer and subsequently quenching the film to a temperature of below Tg of the copolyamide, while the film is transported in a direction, referred to as machine direction;
c) Stretching the film obtained after quenching in a direction parallel to the machine direction (MD-stretching) with a draw ratio DR_{MD} at a temperature of at least Tg of the copolyamide;
d) Stretching the film obtained after MD stretching in a direction transversal to the machine direction (TD-stretching) with a draw ratio DR_{TD} at a temperature of at least Tg+10° C. of the copolyamide;
e) Heat setting the film obtained after cooling and stretching, at a temperature of between Tm−70° C. and Tm of the copolyamide;
   in which Tg and Tm of the copolyamide are determined as described by ASTM D3418-03 in which DR_{MD}/DR_{TD}) is at least 0.8 and DR_{MD}×DR_{TD}) is at least 10.

Inventors now surprisingly have found that employing a process according to the invention provides a film, which can be better printed, as the film exhibits less shrinkage or expansion, especially in transversal direction (TD), due to humidity. Without wishing to be bound by theory, inventors believe that employing a copolyamide comprising:
i. At least 75 wt % monomeric units derived from caprolactam, and further monomeric units derived from diamines X and/or diacids Y and/or aminoacids Z in a summed amount of between 0.2 to 25 wt %; or
ii. At least 75 wt % monomeric units derived from hexamethylene diamine and adipic acid, and further monomeric units derived from diamines X and/or diacids Y and/or aminoacids Z in a summed amount of between 0.2 to 25 wt %;
   allows for higher stretching ratio's in machine direction (MD), and thus allowing DR_{MD}×DR_{TD} being at least 10, while satisfying MD/TD is at least 0.8. These process parameters allow better printability of a film while retaining barrier and mechanical properties.

Draw ratio can be determined as follows:

A line with a length L₀ is drawn on the film in machine direction. After drawing the film in machine direction, the obtained line is measured to be L. The draw ratio in machine direction is then DR_{MD}=L/L₀. For draw ratio in the transversal direction DR_{TD}, the procedure is performed in the transversal direction.

The process is carried out with the draw ratio DR_{MD} and DR_{TD} satisfying the formula's DR_{MD}/DR_{TD} is at least 0.8 and DR_{MD}×DR_{TD} is at least 10.

Preferably, DR_{TD} is at least 2.5, as this allows for better mechanical properties in transversal direction, more preferably DR_{TD} is at least 2.8 and even more preferred at least 3.0. The maximum value of DR_{TD} depends on the equipment and stretchability of the material and may be as high as 7, preferably at most 6.

Preferably, DR_{MD}/DR_{TD} is at least 1.0, more preferred at least 1.10, even more preferred at least 1.15, and most preferred at least 1.2. DR_{MD}/DR_{TD} being higher allows for less shrinkage or expansion in transversal direction under influence of humidity. The maximum value of DR_{MD}/DR_{TD} depends on the equipment and stretchability of the material and may be as high as 2.0, preferably at most 1.7.

DR_{MD}×DR_{TD} is at least 10, preferably at least 11, more preferably at least 12, and most preferably at least 12.5. The advantage of having DR_{MD}×DR_{TD} higher is that a higher amount of film can be produced, as well as better barrier properties are attained. This allows employment of thinner films, and thus causes less waste in the value chain. The maximum value of DR_{MD}×DR_{TD} depends on the equipment and stretchability of the material and may be as high as 20, preferably at most 18.

With “copolyamide” is herein understood to be a polymer derived from mixing monomers and polymerizing those into a polymer, in contrast to mixing polymers and reacting those into other polymers.

Width of the film is understood to be perpendicular to the machine direction. Length of the film is understood to be parallel to machine direction. Machine direction is a known term for a person skilled in the art.

Further monomeric units derived from diamines X and/or diacids Y and/or aminoacids Z is hereby understood to be monomeric units different from the at least 75 wt % monomeric units derived from caprolactam in option i) or the at least 75 wt % monomeric units derived from hexamethylene diamine and adipic acid in option ii).

The individual steps will be further elucidated and all embodiments of the individual process steps as described are hereby explicitly combined as it is clear to a person skilled in the art that combinations of the preferred embodiments of the process steps are considered part of the invention.

### Step a)

Melting is hereby understood to heat a composition to a temperature of at least above Tm of the copolyamide. This can for example be achieved by an extruder. Preferably the composition comprises at least 90 wt % with respect to the total amount of the composition of a copolyamide, more preferably at least 95 wt %, and even more preferred at least 98 wt %.

### Step b)

Casting through a planar die is for example performed by extruding the abovementioned melt through a planar die to form a film. Planar die is understood to be a die with its largest width in a horizontal position. The film is quenched to a temperature of below Tg of the copolyamide, which can be performed for example by bringing the film into contact with a metal chill roll, having temperature below Tg of the abovementioned copolyamide. The film is transported in a direction, referred to as machine direction.

### Step c)

MD-stretching is performed at a temperature of at least Tg of the copolyamide, preferably at least Tg+10° C., more preferably at least Tg+20° C., as this facilitates the film drawability. MD stretching may be performed at a temperature as high as Tg+100° C., as long as the temperature is below Tm of the copolyamide or melting temperature of a plastic of another layer if present. MD-stretching is performed with a draw ratio DR_{MD}.

### Step d)

TD-stretching is performed at a temperature of at least Tg+10° C. of the copolyamide, preferably at least Tg+20° C., and even more preferred at least Tg+40° C., as this facilitates the film drawability. Preferably, the temperature of TD-stretching is higher than the temperature of MD-stretching, as this results in improved drawability of the film. TD stretching may be performed at a temperature as high as Tg+100° C., as long as the temperature is below Tm of the copolyamide or melting temperature of a plastic of another layer if present. TD-stretching is performed with a draw ratio DR_{TD}).

### Step e)

After cooling as in step a) and stretching as in steps c) and d), the film is heat-set at a temperature of between Tm−70° C. and Tm of the copolyamide, preferably at a temperature of between Tm−15° C. and Tm, as this allows for reaching the equilibrium level of crystallinity of the film. Preferably heat-set is performed during at least 1 second, more preferably at least 2 seconds, even more preferred at least 3 seconds, while maintaining the film at a temperature of between Tm−70° C. and Tm of the polyamide, preferably at a temperature of between Tm−15° C. and Tm.

Step e) is essential to obtain a film with good dimensional stability, i.e. low hot air shrinkage in transversal direction. The process according to the invention results in a film which is distinguished from so-called shrinkable films, as it keeps its dimensions upon heating. Shrinkable films will decrease their dimensions when subjected to hot air or hot water, which is undesirable for the films obtained by the process according to the invention.

Option i) of the composition in the present invention is based on at least 75 wt % monomeric units derived from caprolactam, and the copolyamide may be denoted as for example, PA-6/XY, PA-6/Z, PA-6/Z/XY. Option ii) is based on at least 75 wt % monomeric units derived from hexamethylene diamine and adipic acid, and the copolyamide may be denoted as for example PA-66/XY, PA-66/Z, PA-66/XY/Z. The copolyamide may also be a blend of copolyamides. Nomenclature is as described in Nylon Plastics Handbook, Melvin I. Kohan, Hanser Publishers, 1995, page 5.

Monomeric unit derived from caprolactam is also known by the chemical formula (1):

—HN(CH₂)₅CO— (1)

Monomeric unit derived from hexamethylene diamine and adipic acid is also known by the chemical formula (2), and may also be derived from the salt of hexamethylene diamine and adipic acid:

HN(CH₂)₆NHCO(CH₂)₄CO— (2)

Monomeric units derived from an aminoacid include lactams, which will upon ring opening constitute an aminoacid. Suitable aminoacids Z include for example aminodecanoic acid, aminoundecanoic acid and aminododecanoic acid.

Diamines X may be chosen from for example 1,4-diaminobutane, 1,5-diaminopentane, 1,6-diaminohexane, isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane (DMDC), p-xylylenediamine, m-xylylenediamine, and 3,6-bis(aminomethyl)norbornane.

Diacids Y may be chosen from for example 1,6-hexanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid, isophthalic acid (I), terephthalic acid (T), 4-methylisophthalic acid, 4-tert-butylisophthalic acid, 1,4-naphthalenedicarboxylic acid and 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid.

The composition may contain additives, which for example include anti-block agents as known to a person skilled in the art, colorants, oxygen scavengers, stabilizers. The composition may also comprise further polyamides and or copolyamides.

Preferably, the process is performed with a composition comprising at least 50 wt %, more preferably at least 90 wt %, even more preferred at least 95 wt %, and most preferred at least 98 wt %, with respect to the total amount of the composition of a copolyamide comprising:
i. At least 80 wt %, more preferably at least 85 wt %, even more preferred at least 90 wt % monomeric units derived from caprolactam, and further monomeric units derived from diamines X and/or diacids Y and/or aminoacids Z in a summed amount of between 0.5 to 10 wt %, more preferably between 0.8 to 5 wt %; or
ii. At least 80 wt %, more preferably at least 85 wt %, even more preferred at least 90 wt % monomeric units derived from hexamethylene diamine and adipic acid, and further monomeric units derived from diamines X and/or diacids Y and/or aminoacids Z in a summed amount of between 0.5 to 10 wt %, more preferably between 0.8 to 5 wt %.

Preferably, the process is performed with a composition comprising at least 50 wt %, more preferably at least 90 wt %, even more preferred at least 95 wt %, and most preferred at least 98 wt %, with respect to the total amount of the composition of a copolyamide comprising:
i. At least 75 wt % preferably at least 80 wt %, more preferably at least 85 wt %, even more preferred at least 90 wt % monomeric units derived from caprolactam, and further monomeric units derived from hexamethylene diamine and adipic acid in a summed amount of between 0.2 to 25 wt %, preferably between 0.5 to 10 wt %, more preferably between 0.8 to 5 wt %.
   This copolyamides, also denoted as PA6/66, are readily available and has the advantage that more stable film drawing process with less film breakages can be performed as compared to PA6 homopolymer.

In another embodiment, the composition employed in the process comprises at least 50 wt %, preferably at least 90 wt %, more preferably at least 95 wt %, and even more preferred at least 98 wt %, with respect to the total amount of the composition of a copolyamides comprising:
i. At least 75 wt %, preferably at least 80 wt %, more preferably at least 85 wt %, even more preferred at least 90 wt % monomeric units derived from caprolactam, and further monomeric units derived from diamines X and/or diacids Y and/or aminoacids Z in a summed amount of between 0.5 to 10 wt %, more preferably between 0.8 to 5 wt %; or
ii. At least 75 wt %, preferably at least 80 wt %, more preferably at least 85 wt %, even more preferred at least 90 wt % monomeric units derived from hexamethylene diamine and adipic acid, and further monomeric units derived from diamines X and/or diacids Y and/or aminoacids Z in a summed amount of between 0.5 to 10 wt %, more preferably between 0.8 to 5 wt %;

Wherein diamine X or diacid Y or an aminoacid Z is cyclic, as this allows presence of X, Y or Z in amounts less than compared to presence of non-cyclic X, Y or Z, which results in more favorable properties, such as mechanical properties as well as gas barrier properties. Cyclic is hereby understood to have a ring-like chemical structure upon presence in the polyamide, such as aromatic structures as well as alicyclic structures.

Monomeric unit based on caprolactam is not cyclic as caprolactam will open its structure when forming a polyamide and is thus present as a non-cyclic monomeric unit in a polyamide.

Preferably, the further monomeric unit derived from diamines X is chosen from the group of isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane, p-xylylenediamine, m-xylylenediamine, and 3,6-bis(aminomethyl)norbornane. Preferably, the further monomeric unit derived from diacid Y is chosen from the group of isophthalic acid (I), terephthalic acid (T), 4-methylisophthalic acid, 4-tert-butylisophthalic acid, 1,4-naphthalenedicarboxylic acid, 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid.

More preferred, the further monomeric units derived from diamines X and diacids Y in i) or ii) are chosen from a combination of
isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane, p-xylylenediamine, m-xylylenediamine, and 3,6-bis(aminomethyl)norbornane; and
isophthalic acid (I), terephthalic acid (T), 4-methylisophthalic acid, 4-tert-butylisophthalic acid, 1,4-naphthalenedicarboxylic acid, 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid;
   in a summed amount of at least 0.2 wt %, preferably at least 0.5 wt %, more preferably at least 0.8 wt % and most preferred at least 0.95 wt %, as this allows for even lower amounts of further monomeric units derived from diamine X and diamine Y being present and keeps the mechanical properties of the film sufficient.

The present invention also relates to a sequentially stretched biaxially oriented film, obtainable by the process as described above. The preferred embodiments with respect to the copolyamides, as well as the preferred embodiments with respect to the processing steps are hereby explicitly combinable, into embodiments incorporated in this invention.

The sequentially stretched biaxially oriented film according to the invention may be a monolayer or a multilayer. Other layers may be present such as polyamide, such as for example polyamide-6 or polyamide-66, polyethylene, EVOH, as well as tie layers. These may be directly casted via a die in step b) or for example laminated separately after preparation of the individual layers. Multilayer films have the advantage that properties of individual layers can be combined, which may for example lead to higher barrier properties.

Measurement of Tg and Tm of copolyamide is performed by method described in ASTM D3418-03: Tg corresponds to the midpoint temperature Tmg and Tm corresponds to the melting peak temperature Tmp, as described in the section 10 of ASTM D3418-03. Both Tg and Tm are measured in a temperature scan at 10° C./min.

The sequentially stretched biaxially oriented film according to the invention is highly suitable for flexible packaging, as it allows easily printing of the film, with less distortion of the picture on the film. The invention thus also relates to a sequentially stretched biaxially oriented film, which is at least partially printed, as well as flexible packaging comprising this film. The invention also relates to food-packaging. Another advantage of the film according to the invention is that upon cutting of the film, high quality edges are obtained.

The invention also relates to a sequentially stretched biaxially oriented film, obtainable by the process as described above, in which the film shows a tensile modulus in machine direction (E_{MD}) and tensile modulus in transversal direction (E_{TD}) satisfying (|E_{MD}−E_{TD}|/(E_{MD}))×100% is less than 20%, in which E_{MD} and E_{TD} are measured according to ASTM-D882, and wherein E_{MD} is at least 2000 MPa. Preferably, E_{MD} is at least 3000 MPa, more preferably E_{MD} is at least 4000 MPa. A higher tensile modulus allows for stiffer films, which allows easier handling.

The invention also relates to a sequentially stretched biaxially oriented film, obtainable by the process as described above, in which the film shows a tensile strength σ (sigma) in machine direction (σ_{MD}) and tensile strength in transversal direction (σ_{TD}) satisfying (|σ_{MD}−σ_{TD}|/σ_{MD})×100% is less than 20%, in which σ_{MD} and σ_{TD} are measured according to ASTM-D882 at a temperature of 23° C., and wherein σ_{MD} is at least 200 MPa. Preferably, σ_{MD} is at least 250 MPa, more preferably, σ_{MD} is at least 300 MPa. A higher tensile strength also allows for stiffer films, which allows easier handling.

The invention also relates to a sequentially stretched biaxially oriented film in which the oxygen permeability as measured according to ASTM D3985 at 23° C. and 0% relative humidity is less than 1.5 cm3 mm/(m2 day atm). Lower oxygen permeability makes film more suitable for fresh food packaging applications as it prolongs shelf-life of the packaged food.

The invention also relates to a sequentially stretched biaxially oriented film wherein the hot air shrinkage (HAS) value in TD is at most 1.5% and the HAS value in MD is at most 1% as measured according to ASTM D 1204-02 at 160° C. for 5 minutes. Lower values of HAS ensure good stability of the film in further processing steps, which involve increased temperatures, such as, e.g., hot melt lamination process.

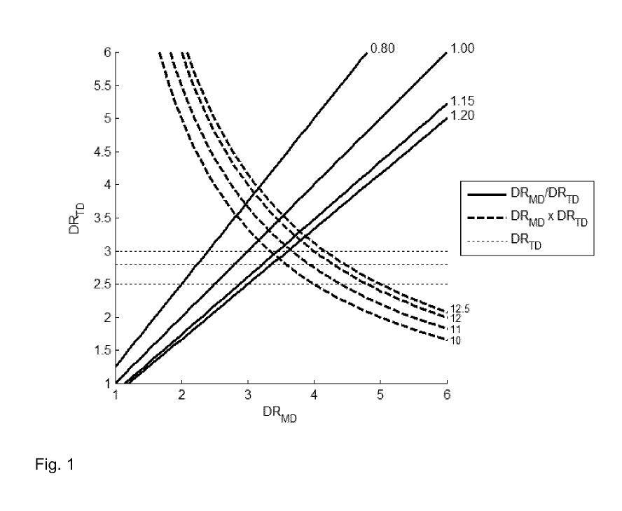

FIG. 1 shows a graph in which the values of the draw ratio in transverse direction DR_{TD} and the values of the draw ratio in machine direction DR_{MD} according to this invention are illustrated.

The thick solid lines correspond a certain ratio between DR_{TD} and DR_{MD} (the value of the ratio is indicated next to each line). According to the present invention, this ratio DR_{MD}/DR_{TD} is at least 0.8, corresponding to the region below the line DR_{MD}/DR_{TD}=0.8. the preferred embodiments, with DR_{MD}/DR_{TD} at least 1, at least 1.15, and at least 1.20 are also denoted.

The dashed thick lines correspond to a certain product between DR_{TD} and DR_{MD} (the value of the product is indicated next to each line). According to the present invention, the product DR_{MD}×DR_{TD} is at least 10, corresponding to the region above the line DR_{MD}×DR_{TD}=10. The preferred embodiments, with DR_{MD}×DR_{TD} at least 11, at least 12, and at least 12.5 are also denoted.

Horizontal dashed thin lines correspond to certain values of DR_{TD}. According to a preferred embodiment of the present invention, the DR_{TD} value is at least 2.5, corresponding to the region above the line DR_{TD}=2.5. The more preferred embodiments, with DR_{TD} of at least 2.7, and at least 3 are also denoted.

The invention is further illustrated with the following examples and comparative experiments.

### Experimental Part

### Test Methods

The tensile modulus of the films in machine direction (E_{MD}) and in transverse direction (E_{TD}) were measured by the method according to ASTM-D882 at 23° C.

The tensile strength of the films in machine direction (σ_{MD}) and in transverse direction (σ_{TD}) were measured by the method according to ASTM-D882 at 23° C.

The oxygen permeability of the films was measured by the method according to ASTM D3985 at 23° C. and 0% relative humidity.

The hot air shrinkage (HAS) of the films in machine direction and in transverse direction were measured by the method according to ASTM D 1204-02 at 160° C. for 5 minutes.

### Materials

For the experiments a polyamide-6 and a polyamide-6/IPDT copolyamide were used. The properties of the co- or homopolyamides are given in Table 1. Polyamide-6/IPDT is a copolyamide in which 1.0 wt % monomeric units are derived from isophorone diamine X and terephthalic acid Y, besides 99 wt % monomeric units derived from caprolactam. Polyamide-6 is a homopolyamide consisting of monomeric units derived from caprolactam.

TABLE 1
Properties of (co)polyamides

| | Relative viscosity in | | |
|---|---|---|---|
| | 90 wt % formic acid | Tg | Tm |
| PA6 homopolymer | 2.7 | 53° C. | 220° C. |
| PA6/IPDT copolymer | 2.8 | 54° C. | 219° C. |

### EXAMPLES

3-layered films are prepared. The inner layer is composed of homopolyamide PA6 or copolyamide 6/IPDT with 1 wt % monomeric units derived from isophorone diamine and terephthalic acid. The outer layers composition contains the same co- or homopolyamide as the inner layer plus 1 wt % antiblock masterbatch in which the weight percentage is with respect to the total weight of composition. Antiblock masterbatch is a conventional masterbatch containing 20 wt % silica with respect to the total weight of antiblock masterbatch, for the purpose of improving the slip and antiblock characteristics of the resulting film.

During film production, the first stretching step (in MD) is performed by stretching the film in a gap between two roller stands, with the second roller stand having higher rotational velocity than the first one. The ratio between the velocity of the second and the first roller stand is reported below as DR_{MD}.

Prior to the MD stretching step the film is brought to the temperature of 70° C. via a contact with the heated rolls of the first roller stand. After the MD stretching, the film is cooled by a contact with unheated rolls of the second roller.

The second stretching step (in TD) is performed in a tenter frame situated in an air heated oven. The film is heated by hot air with the temperature of 180° C.

In the heatsetting step the film is heatset is an air heated oven. The air temperature during heatsetting is set to 190° C.

### Example 1: Copolyamide PA6/IPDT is Used for all Three Layers of the Film

After extrusion and casting, the film is stretched 3.5 times in MD and 3.4 times in TD. DR_{MD}/DR_{TD} is 1.03 and DR_{MD}×DR_{TD} is 11.9. After stretching the film is heatset and wound on a roll. Printability is good.

### Example 2: Copolyamide PA6/IPDT is Used for all Three Layers of the Film

After extrusion and casting, the film is stretched 3.5 times in MD and 3.1 times in TD. DR_{MD}/DR_{TD} is 1.13 and DR_{MD}×DR_{TD} is 10.9. After stretching the film is heat-set and wound on a roll. Printability is better than Example 1.

### Example 3: Copolyamide PA6/IPDT is Used for all Three Layers of the Film

After extrusion and casting, the film is stretched 3.4 times in MD and 3.9 times in TD. DR_{MD}/DR_{TD} is 0.87 and DR_{MD}×DR_{TD} is 13.26. After stretching the film is heatset and wound on a roll. Modulus in MD direction is E_{MD}=5110 MPa and in TD direction E_{TD}=4483 MPa. So, (|EMD−ETD|/(EMD))×100%=12% is less than 20%. Tensile strength in MD direction is σ_{MD}=202 MPa and in TD direction σ_{TD}=235 MPa. So, (|σ_{MD}−σ_{TD}|/σ_{MD})×100%=17% is less than 20%. Hot air shrinkage at 160° C. for 5 minutes is 0.98% in MD and 1.00% in TD. Oxygen permeability at 23° C. and 0% relative humidity is 0.99 cc mm/(m² day). Printability is good.

### Comparative Example A: Homopolymer PA6 is Used for all Three Layers of the Film

After extrusion and casting, the film is stretched 2.6 times in MD and 3.7 times in TD. DR_{MD}/DR_{TD} is 0.7 and DR_{MD}×DR_{TD} is 9.6. After stretching the film is heatset and wound on a roll. Printability is worse compared to Examples 1-3.

### Comparative Example B: Homopolymer PA6 is Used for all Three Layers of the Film

After extrusion and casting, the film is stretched 3.5 times in MD and 3.4 times in TD. DR_{MD}/DR_{TD} is 1.03 and DR_{MD}×DR_{TD} is 11.9. After stretching the film is heatset and wound on a roll. Production process was not feasible because of numerous breaks during TD stretch. It is clear that a homopolyamide cannot be satisfactory processed while having DR_{MD}/DR_{TD} being at least 0.8 and DR_{MD}×DR_{TD} being at least 10. Printability was not tested since film could not be produced in a stable continuous manner.

### Comparative Example C: Copolyamide PA6/IPDT is Used for all Three Layers of the Film

After extrusion and casting, the film is stretched 2.6 times in MD and 3.7 times in TD. DR_{MD}/DR_{TD} is 0.7 and DR_{MD}×DR_{TD} is 9.6. Printability is worse as compared to Examples 1-3.

### Comparative Example D: Homopolymer PA6 is Used for all Three Layers of the Film

After extrusion and casting, the film is stretched 3.4 times in MD and 3.9 times in TD. DR_{MD}/DR_{TD} is 0.87 and DR_{MD}×DR_{TD} is 13.26. After stretching the film is heatset and wound on a roll. Production process was not feasible because of numerous breaks during TD stretch. It is clear that a homopolyamide cannot be satisfactory processed while having DR_{MD}/DR_{TD} being at least 0.8 and DR_{MD}×DR_{TD} being at least 10. Printability was not tested since film could not be produced in a stable continuous manner.

### Comparative Example E: Copolyamide PA6/IPDT is Used for all Three Layers of the Film

After extrusion and casting, the film is stretched 3.0 times in MD and 4.0 times in TD. DR_{MD}/DR_{TD} is 0.75 and DR_{MD}×DR_{TD} is 12.00. After stretching the film is heatset and wound on a roll. Modulus in MD direction is E_{MD}=4888 MPa and in TD direction E_{TD}=4057 MPa. So, (|E_{MD}−E_{TD}|/(E_{MD}))×100%=17% is less than 20%. Tensile strength in MD direction is σ_{MD}=224 MPa and in TD direction σ_{TD}=335 MPa. So, (|σ_{MD}−σ_{TD}|/σ_{MD})×100%=50% is more than 20%. Hot air shrinkage at 160° C. for 5 minutes is 0.88% in MD and 1.17% in TD. Oxygen permeability at 23° C. and 0% relative humidity is 1.01 cc mm/(m² day). Printability is worse compared to Examples 1-3.

### Comparative Example F: Homopolymer PA6 is Used for all Three Layers of the Film

After extrusion and casting, the film is stretched 3.0 times in MD and 4.0 times in TD. DR_{MD}/DR_{TD} is 0.75 and DR_{MD}×DR_{TD} is 12.00. After stretching the film is heatset and wound on a roll. Modulus in MD direction is E_{MD}=5868 MPa and in TD direction E_{TD}=4256 MPa. So, (|E_{MD}−E_{TD}|/(E_{MD}))×100%=27% is more than 20%. Tensile strength in MD direction is σ_{MD}=217 MPa and in TD direction σ_{TD}=308 MPa. So, (|σ_{MD}−σ_{TD}|/σ_{MD})×100%=42% is more than 20%. Hot air shrinkage at 160° C. for 5 minutes is 0.83% in MD and 0.97% in TD. Oxygen permeability at 23° C. and 0% relative humidity is 1.00 cc mm/(m² day). Printability is worse compared to Examples 1-3.

1. Process for preparing a sequentially stretched biaxially oriented film, comprising the following steps:
a) Melting a composition comprising at least 50 wt % with respect to the total amount of the composition of a copolyamide comprising:
i. At least 75 wt % monomeric units derived from caprolactam, and further monomeric units derived from diamines X and/or diacids Y and/or aminoacids Z in a summed amount of between 0.2 to 25 wt %; or
ii. At least 75 wt % monomeric units derived from hexamethylene diamine and adipic acid, and further monomeric units derived from diamines X and/or diacids Y and/or aminoacids Z in a summed amount of between 0.2 to 25 wt %; into a polymer melt;
b) Casting the polymer melt through a planar die to form a film of at least one layer and subsequently quenching the film to a temperature below Tg of the copolyamide, while the film is transported in a direction, referred to as machine direction;
c) Stretching the film obtained after quenching in a direction parallel to the machine direction (MD-stretching) with a draw ratio DR_{Q} at a temperature of at least Tg of the copolyamide;
d) Stretching the film obtained after MD stretching in a direction transversal to the machine direction (TD-stretching) with a draw ratio DR_{MD} at a temperature of at least Tg+10° C. of the copolyamide;
e) Heat setting the film obtained after cooling (step b) and stretching (steps c) and d)), at a temperature of between Tm−70° C. and Tm of the copolyamide;
in which Tg and Tm of the copolyamide are determined as described by ASTM D3418-03, with a heating and cooling rate of 10° C. per minute, and in which DR_{Q}/DR_{TD} is at least 0.8 and DR_{MD}×DR_{TD} is at least 10.

2. Process according to claim 1, wherein DR_{TD} is at least 2.5.

3. Process according to claim 1, wherein DR_{MD}/DR_{TD} is at least 1.0, preferably at least 1.15.

4. Process according to claim 1, wherein the composition comprises at least 90 wt % with respect to the total amount of the composition of the copolyamide.

5. Process according to claim 1, wherein at least one of the further monomeric units derived from diamines X, diacids Y, aminoacids Z comprises a cyclic unit.

6. Process according to claim 1, wherein the further monomeric units derived from diamines X and diacids Y are cyclic.

7. Process according to claim 1, wherein the further monomeric unit derived from diamines X is chosen from the group of isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane, p-xylylenediamine, m-xylylenediamine, and 3,6-bis(aminomethyl)norbornane.

8. Process according to claim 1, wherein the further monomeric unit derived from diacids Y is chosen from the group of isophthalic acid (I), terephthalic acid (T), 4-methylisophthalic acid, 4-tert-butylisophthalic acid, 1,4-naphthalenedicarboxylic acid, 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid.

9. Process according to claim 1, wherein the further monomeric units derived from diamines X and/or diacids Y and/or aminoacids Z in i) or ii) are present in a summed amount of between 0.5 to 10 wt %, preferably between 0.8 to 5 wt %.

10. Process according to claim 1, wherein the further monomeric units derived from diamines X and diacids Y in i) or ii) are chosen from a combination of
isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane, p-xylylenediamine, m-xylylenediamine, and 3,6-bis(aminomethyl)norbornane; and
isophthalic acid (I), terephthalic acid (T), 4-methylisophthalic acid, 4-tert-butylisophthalic acid, 1,4-naphthalenedicarboxylic acid, 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid;
in a summed amount of between 0.8 to 5 wt %.

11. Sequentially stretched biaxially oriented film obtainable by the process according to claim 1, in wherein (|E_{MD}−E_{TD}|/(E_{MD}))×100% is less than 20%, in which E_{MD} and E_{TD} are tensile moduli measured according to ASTM-D882 at a temperature of 23° C., and wherein E_{MD} is at least 2000 MPa.

12. Sequentially stretched biaxially oriented film according to claim 11, wherein (|σ_{MD}−σ_{TD}|/σ_{MD})×100% is less than 20%, in which σ_{MD} and σ_{TD} are tensile strengths measured according to ASTM-D882 at a temperature of 23° C. and wherein σ_{MD} is at least 200 MPa.

13. Sequentially stretched biaxially oriented film according to claim 11, wherein the oxygen permeability as measured according to ASTM D3985 at 23° C. and 0% relative humidity is less than 1.5 cm³ mm/(m² day atm).

14. Sequentially stretched biaxially oriented film according to claim 11, wherein the hot air shrinkage (HAS) in TD is at most 1.5% and the HAS value in MD is at most 1% as measured according to ASTM D 1204-02 at 160° C. for 5 minutes.

15. Sequentially stretched biaxially oriented film, according to claim 11, wherein the film is at least partially printed.
